(19) United States
(12) Patent Application Publication
(10) Pub. No.: US 2026/0212654 A1
(43) Pub. Date: Jul. 23, 2026

(54) SYSTEMS AND METHODS FOR SYNTHETIC TRAINING DATA GENERATION FOR AI RECOGNITION SYSTEMS

(71) Applicant: SYNETIC, INC., WOODINVILLE, WA (US)

(72) Inventors: Octavian Alexandru BLAGA, CHATTANOOGA, TN (US); David Benjamin SCOTT, REDMOND, WA (US); Trevor Thomas SATTERFIELD, OMAHA, NE (US)

(73) Assignee: SYNETIC, INC., WOODINVILLE, WA (US)

(21) Appl. No.: 19/451,314

(22) Filed: Jan. 16, 2026

Related U.S. Application Data
(63) Continuation of application No. PCT/US26/11529, filed on Jan. 16, 2026.
(60) Provisional application No. 63/746,583, filed on Jan. 17, 2025.

(51) Int. Cl. G06V 10/774; G06T 17/00; G06T 19/00

(52) U.S. Cl. CPC G06V 10/7747; G06T 17/00; G06T 19/00; G06T 2219/004

(57) ABSTRACT

Systems and methods are disclosed for training artificial intelligence (AI) recognition models using synthetic training data generated from limited real-world image inputs. One or more two-dimensional images of a real-world object, subject, or scene are received and used to generate a photorealistic three-dimensional synthetic representation. From the synthetic representation, a plurality of synthetic data instances are generated by varying viewpoint, pose, motion, environment, or behavior. The synthetic data is automatically annotated with labels corresponding to behaviors, conditions, or attributes and provided as training data for an AI recognition model. The trained AI recognition model is applied to real-world image data to identify corresponding behaviors or conditions. The disclosed approach reduces reliance on manually labeled real-world data while improving coverage of behaviors and conditions that are difficult to capture consistently.

### RELATED APPLICATIONS

This application claims the benefit of U.S. Provisional Patent Application No. 63/746,583, filed Jan. 17, 2025, and entitled “Computer Method Including AI Training Set Generation For Vision System Identification Of Behaviors,” and PCT/US26/11529, filed Jan. 16, 2026 of the same title, the entire contents of which are hereby incorporated by reference.

### FIELD OF THE INVENTION

The present invention relates generally to systems and methods for artificial intelligence and machine learning, and more particularly to systems and methods for generating, annotating, and utilizing synthetic training data for training, validating, and refining artificial intelligence models. The invention further relates to computer vision, image-based modeling, multi-modal data integration, and automated recognition of objects, behaviors, conditions, or events using learned models derived from synthetic and real-world data sources.

### BACKGROUND OF ART

Artificial intelligence and computer vision systems are commonly trained using large collections of labeled real-world data. Acquiring such data can be time-consuming, expensive, and difficult to scale, particularly when attempting to capture rare events, specific behaviors, or varied environmental conditions.

In some applications, limited camera viewpoints or sparse image data may restrict the ability of conventional training approaches to accurately model objects, behaviors, or conditions of interest. Existing techniques for data augmentation or synthetic data generation may not adequately address these limitations.

Accordingly, there is a continuing need for improved systems and methods for generating training data for artificial intelligence and computer vision systems.

### BRIEF DESCRIPTION OF DRAWINGS

The accompanying drawings, which are incorporated in and constitute a part of this specification, illustrate embodiments of the invention and, together with the description, serve to explain the principles of the invention. The drawings are not drawn to scale.

FIG. 1 is a block diagram illustrating an example system architecture for generating synthetic training data and training an artificial intelligence (AI) recognition system.

FIG. 2 is a diagram illustrating conversion of two-dimensional (2D) image data into a three-dimensional (3D) synthetic representation using a synthetic modeling engine 120.

FIG. 3 is a diagram illustrating generation of synthetic training data from a three-dimensional synthetic representation, including variation of viewpoint, pose, environment, and behavior.

FIG. 4 is a diagram illustrating automatic annotation of synthetic training data, including labeling of behaviors, conditions, attributes, or events within a synthetic environment.

FIG. 5 is a diagram illustrating training and application of an AI recognition model using synthetic training data and application of the trained model to real-world image data.

FIG. 6 is a diagram illustrating user interaction and feedback-driven refinement of the synthetic training dataset, including retraining of the AI recognition model.

FIG. 7 is a diagram illustrating incorporation of multi-modal data inputs into synthetic modeling, synthetic training data generation, or AI recognition.

### DETAILED DESCRIPTION

### System Overview and Architecture

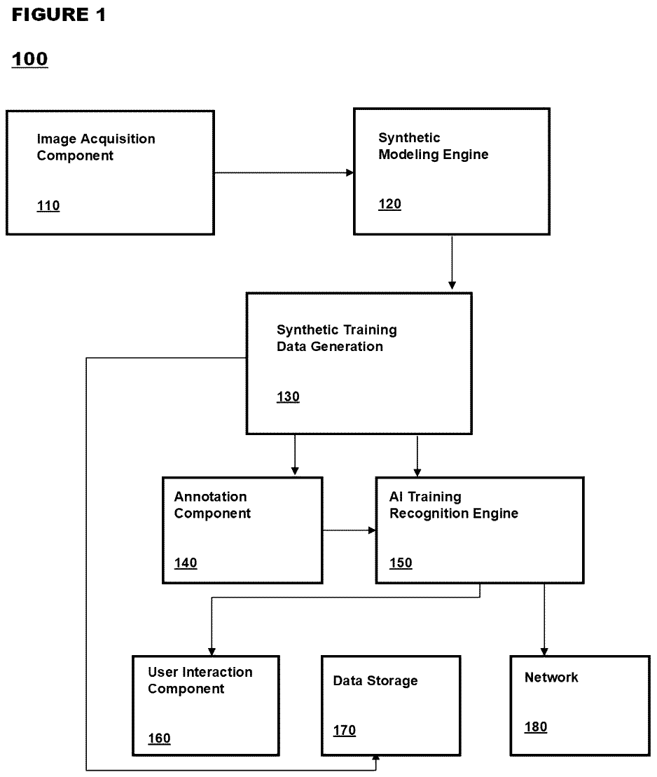

FIG. 1 illustrates an example system architecture 100 for generating synthetic training data and training an artificial intelligence (AI) recognition system.

In one or more embodiments, the disclosed invention comprises a computer-implemented system for training and operating an artificial intelligence (AI) computer vision model using synthetic data generated from limited real-world imagery. The system is structured to separate model generation from recognition and training, thereby enabling scalable creation of high-fidelity training datasets while reducing dependence on manually labeled real-world data.

The system generally includes an image acquisition component 110, a synthetic modeling engine 120, a synthetic training dataset generation process 130, an AI recognition and training engine 150, and one or more data storage 170 and user interaction components 160, which may operate on one or more computing devices connected via a network 180.

The image acquisition component 110 is configured to capture or receive one or more two-dimensional (2D) images 210 of a target object, scene, or subject. In some embodiments, the images are captured using a stationary or calibrated camera from a known vantage point. In other embodiments, a sequence of images captured over time may be used. Metadata 215 associated with the images—such as camera orientation, distance, time, or environmental conditions—may also be received.

The synthetic modeling engine 120 is configured to receive the 2D image data 210 and generate a synthetic three-dimensional (3D) representation of the target object and its surrounding environment. The modeling engine may utilize artificial intelligence techniques, computer graphics engines, or simulation platforms to extrapolate depth, scale, pose, orientation, and spatial relationships from the 2D imagery. The generated 3D model may be viewable or renderable from multiple virtual camera angles and under varied simulated conditions.

Using the synthetic 3D representation, the system generates a synthetic training dataset comprising multiple images, frames, or sequences that represent variations in viewpoint, motion, behavior, lighting, occlusion, environment, or other attributes. In some embodiments, the synthetic data constitutes a majority of the training dataset used by the AI system. In other embodiments, synthetic data may be combined with real-world image data.

The system further includes an annotation and attribute modeling component 140, which labels objects, behaviors, conditions, or events within the synthetic environment. Annotation may occur automatically within the modeling engine based on known attributes of the synthetic model, or semi-automatically with user input 620. Attributes may include physical characteristics, positional data, behavioral states, or indicators of conditions such as injury, abnormal motion, or other events of interest 430.

The AI recognition and training engine is configured to receive the synthetic training dataset and train one or more machine learning models to identify objects, behaviors, or conditions in real-world imagery. The trained AI model may then be applied to input images or video to output identification results, including detection of specific behaviors or conditions corresponding to those represented in the synthetic training data.

In some embodiments, the system includes a user interaction interface that allows a user to review recognition outputs 540, identify target or undesirable behaviors in real-world images, and initiate updates to the synthetic training dataset. User input 620 may be used to refine the modeling parameters, regenerate synthetic data, or retrain the AI recognition model, thereby enabling iterative improvement.

The components of the system may be implemented on a single computing device or distributed across multiple computing systems, including cloud-based or edge-based platforms. Communication between components may occur via wired or wireless networks. Program instructions implementing the disclosed functionality may be stored in one or more non-transitory computer-readable storage media and executed by one or more processors.

### Synthetic Modeling Engine 120

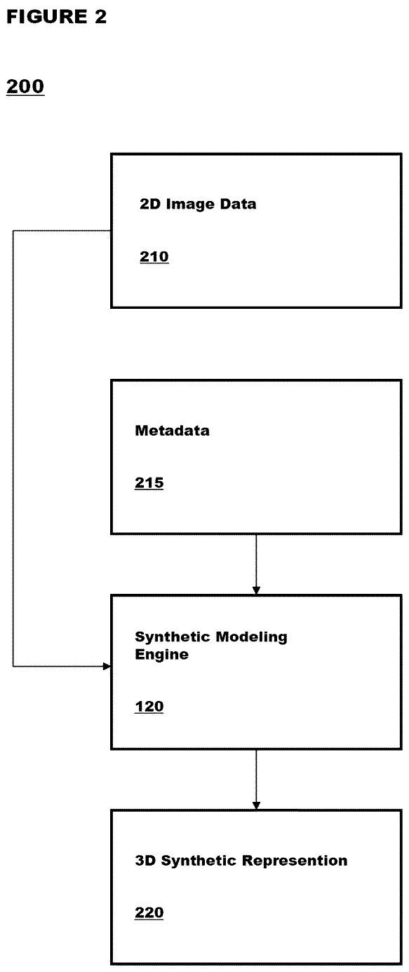

FIG. 2 illustrates conversion of two-dimensional image data into a three-dimensional synthetic representation.

In one or more embodiments, the system includes a synthetic modeling engine 120 configured to generate three-dimensional (3D) representations 220 of real-world objects, subjects, or scenes based on limited two-dimensional (2D) image input. The synthetic modeling engine 120 operates to extrapolate spatial, geometric, and behavioral information from the 2D image data 210 in order to create a realistic 3D modeled environment suitable for synthetic data generation.

The synthetic modeling engine 120 receives one or more 2D images captured from a known or inferable vantage point. In some embodiments, the images are obtained from a single stationary camera. In other embodiments, multiple images or a sequence of images captured over time may be used. The modeling engine may further receive associated metadata 215, including but not limited to camera orientation, distance from the subject, time information, environmental conditions, or reference markers within the scene.

Using the received image data, the synthetic modeling engine 120 generates a baseline 3D model of one or more target objects and, optionally, the surrounding environment. The 3D model may include representations of object geometry, scale, pose, orientation, relative positioning, and spatial relationships. In some embodiments, the modeling engine extrapolates depth and volumetric information from the 2D imagery using artificial intelligence techniques, spatial inference, or known scene parameters.

The synthetic modeling engine 120 is further configured to render the generated 3D model from multiple virtual viewpoints. Virtual camera parameters may be varied to simulate changes in distance, angle, elevation, and perspective relative to the modeled object. Lighting conditions, backgrounds, occlusion elements, cosmetic appearance, or environmental features may also be varied within the synthetic environment to produce a diverse set of rendered outputs.

In some embodiments, the synthetic modeling engine 120 is capable of simulating motion, posture changes, or behaviors of the modeled object over time. For example, the modeling engine may generate a sequence of frames representing movement patterns, behavioral states, or transitions between conditions 430. Such temporal modeling enables creation of synthetic data representing dynamic behaviors that may be difficult to capture consistently in real-world imagery.

The synthetic modeling engine 120 may further support integration of additional data sources to enhance model fidelity. Such data sources may include, by way of example and not limitation, depth data, LiDAR data, radio-frequency data, temperature data, or other sensor-derived inputs. These data sources may be used to refine spatial accuracy, environmental context, or condition modeling within the synthetic environment.

In some embodiments, the synthetic modeling engine 120 operates independently from the AI recognition and training engine, such that modeling and dataset generation may occur separately from recognition model training. This separation allows the synthetic modeling engine 120 to generate reusable, extensible training datasets that can be applied to different AI recognition models 510 or retrained iteratively as modeling parameters are adjusted.

The synthetic modeling engine 120 may be implemented using one or more software platforms, simulation engines, or artificial intelligence systems executing on one or more processors. The modeling engine may operate in real time or offline, and may be deployed on local computing systems, cloud-based infrastructure, or distributed computing environments.

### Synthetic Training Data Generation and Annotation

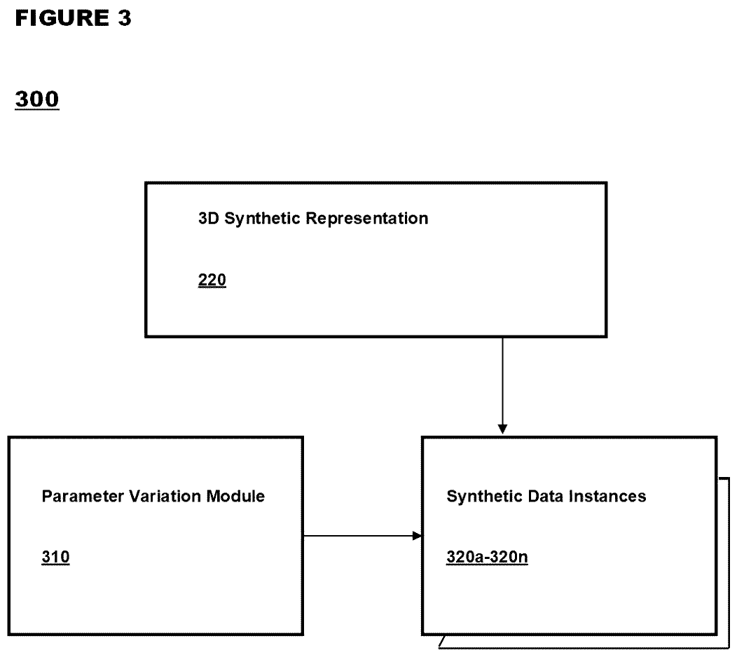

FIG. 3 illustrates generation of synthetic training data from a three-dimensional synthetic representation.

In one or more embodiments, the system is configured to generate synthetic training datasets based on the three-dimensional (3D) representations 220 produced by the synthetic modeling engine 120. The synthetic training datasets are structured for use in training artificial intelligence (AI) computer vision and recognition models and may include still images, image sequences, video frames, or other data representations derived from the synthetic environment.

Using the generated 3D model, the system produces a plurality of synthetic data instances 320a-320n by varying one or more modeling parameters. Such parameters may include, by way of example and not limitation, object pose, orientation, scale, motion, camera viewpoint, lighting conditions, background environment, occlusion elements, or temporal progression. As a result, a diverse and feature-rich dataset may be created from a limited number of real-world images.

In some embodiments, the synthetic training dataset constitutes a majority portion of the data used to train the AI recognition system. In other embodiments, synthetic data may be combined with real-world image data to augment or balance the training dataset. The relative proportions of synthetic and real data may be configurable depending on application requirements.

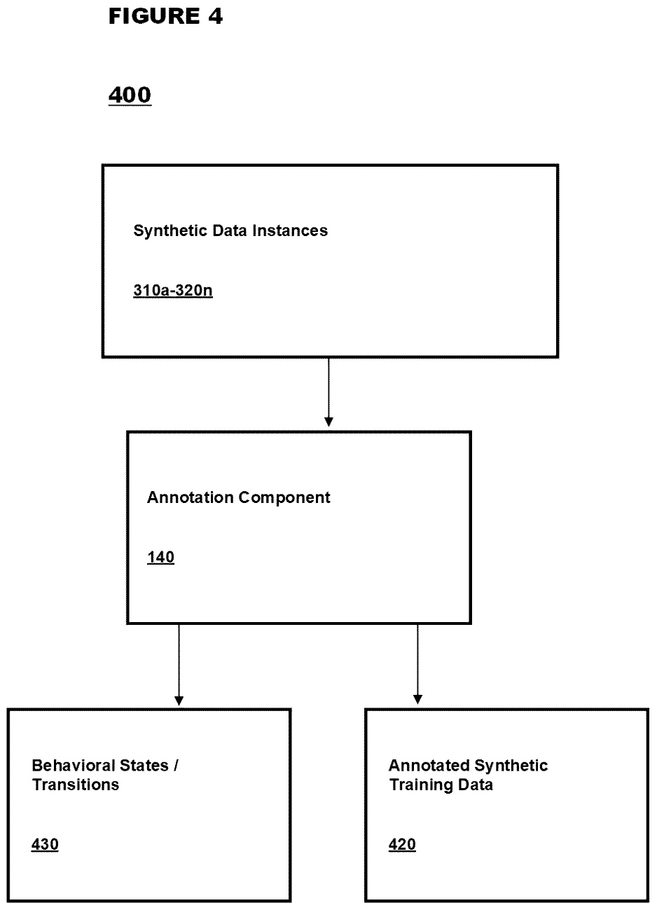

FIG. 4 illustrates automatic annotation of synthetic training data.

The system further includes an annotation component 140 configured to associate labels, attributes, or metadata 215 with the synthetic data instances 320a-320n. Annotation may be performed automatically within the synthetic environment based on known characteristics of the modeled objects, behaviors, or conditions. Because the attributes of the synthetic model are defined or generated within the modeling engine, labeling may occur without manual pixel-level annotation of real-world images.

Annotated attributes may include object identity, spatial location, orientation, posture, motion characteristics, behavioral state, or indicators of conditions or events of interest. In some embodiments, annotation includes labeling of behaviors or behavior transitions across a sequence of synthetic frames. In other embodiments, annotation includes labeling of physical or environmental attributes that may be inferred from the modeled scene.

In some embodiments, the annotation process may incorporate user input 620. A user may identify a target behavior, condition, or event within a real-world image or video, and the system may generate corresponding synthetic representations 220 and annotations within the training dataset. User input 620 may be used to guide selection of modeling parameters, define undesirable or target behaviors, or validate automatically generated annotations.

The annotated synthetic training data 420 may be stored in one or more data repositories and formatted for compatibility with downstream AI training pipelines. The synthetic data and associated annotations may be reused, extended, or modified without re-capturing real-world imagery, thereby enabling rapid iteration and refinement of training datasets.

By generating and annotating training data within a synthetic modeling environment, the system reduces reliance on manual labeling processes, improves coverage of rare or difficult-to-capture behaviors, and enables consistent representation of conditions across a wide range of simulated scenarios.

### AI Recognition and Training Engine

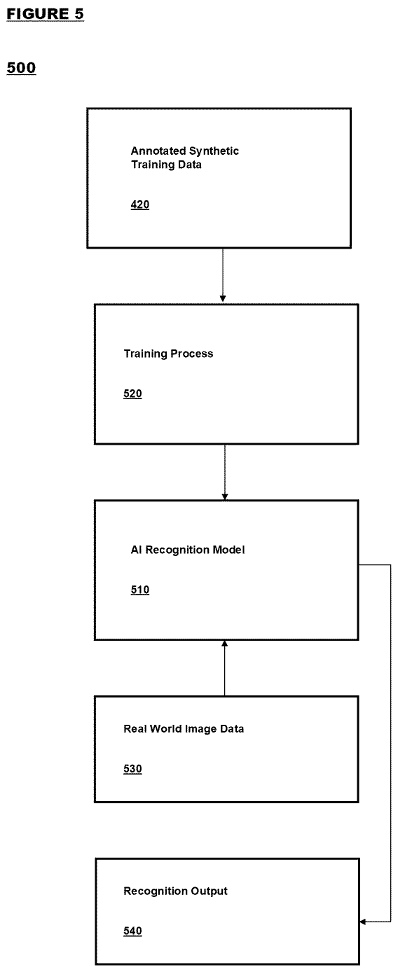

FIG. 5 illustrates training and application of an AI recognition model.

In one or more embodiments, the system includes an AI training and recognition engine 150 configured to train one or more artificial intelligence (AI) models using the synthetic training datasets generated by the system and to apply the trained models to identify objects, behaviors, conditions, or events in real-world image data.

The AI training and recognition engine 150 receives the annotated synthetic training dataset 420 and uses the dataset to train a machine learning model for computer vision or pattern recognition. The trained model may be configured to identify one or more attributes represented in the synthetic data, including object identity, spatial characteristics, motion patterns, behavioral states, or condition indicators. Training process 520 may be performed using supervised, semi-supervised, or other learning techniques.

In some embodiments, the synthetic training dataset used for training the AI model comprises a majority of model-generated data relative to real-world image data. In other embodiments, synthetic data and real-world data may be combined to improve generalization or validation performance. The system may support retraining or incremental training as additional synthetic data or annotations are generated.

Once trained, the AI recognition model 510 may be applied to input image data captured from real-world environments. The input data may include still images or video streams captured from one or more cameras. The recognition engine processes the input image data and outputs identification results corresponding to the attributes or behaviors represented in the training dataset.

Identification results may include detection of specific behaviors, conditions, or events, such as abnormal motion patterns, behavioral states, or other indicators of interest. In some embodiments, the recognition engine outputs spatial localization information, confidence scores, or temporal identification of behaviors across multiple frames.

In some embodiments, the recognition engine may utilize the trained model to infer attributes that are not directly observable in a single 2D image by leveraging patterns learned from the synthetic 3D training data. For example, recognition results may include identification of behaviors or conditions based on inferred posture, motion, or spatial relationships learned during training.

The system may further support validation of recognition outputs 540 using real-world image or video data 530. Validation results may be used to assess recognition accuracy, refine modeling parameters, or guide further generation of synthetic training data.

The AI training and recognition engine 150 may be implemented on one or more computing systems and may be deployed in centralized, distributed, cloud-based, or edge-based environments. The trained recognition model may be stored, updated, or deployed independently of the synthetic modeling engine 120.

### User Interaction and Feedback-Driven Dataset Refinement

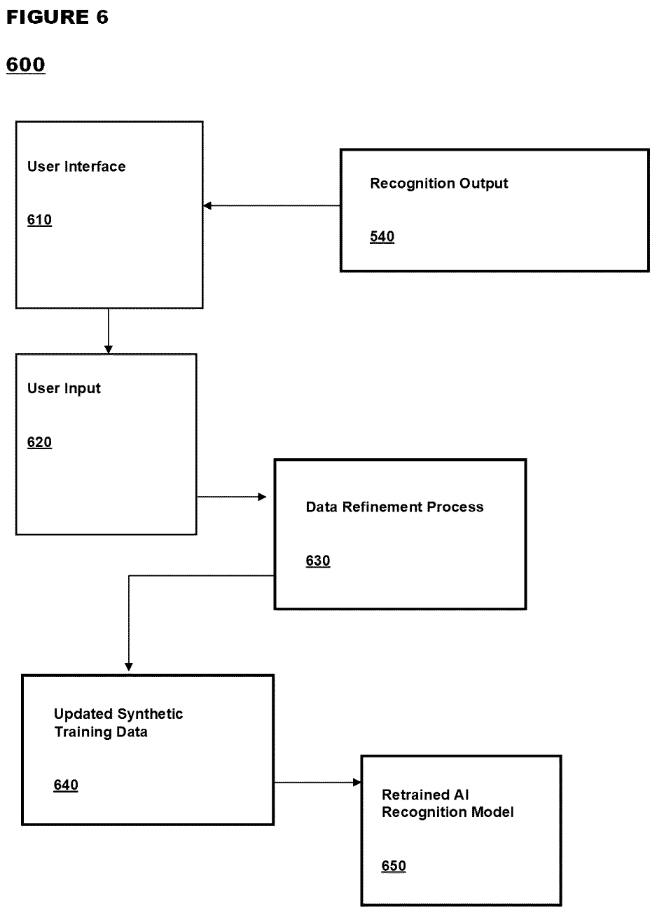

FIG. 6 illustrates user interaction and feedback-driven refinement.

In one or more embodiments, the system includes a user interaction component 160 configured to allow a user to review outputs generated by the AI recognition engine and to influence refinement of the synthetic training dataset. The user interaction component 160 may be provided through a graphical user interface 610, dashboard, or other input/output mechanism accessible via a computing device.

The user interaction component 160 enables a user to view recognition results generated from real-world image data, including identified objects, behaviors, conditions, or events. In some embodiments, the user may select or highlight one or more portions of an image or video corresponding to a target behavior, condition, or undesirable event. User selections may be provided as feedback to the system.

Based on user input 620, the system may update one or more parameters used by the synthetic modeling engine 120 or the training dataset generation component. For example, user input 620 may define additional behaviors to be modeled, adjust thresholds or attributes associated with existing behaviors, or identify conditions that were incorrectly classified by the recognition engine.

In response to the user input 620, the system may generate additional synthetic data instances 320a-320n representing the selected behaviors or conditions and incorporate the newly generated data into the synthetic training dataset. The annotation component 140 may automatically label the newly generated synthetic data based on the defined attributes or behaviors.

The updated synthetic training dataset 640 may then be used to retrain or further train the AI recognition model 510. In some embodiments, retraining may occur iteratively, allowing recognition accuracy to improve over time as additional user feedback is incorporated. In other embodiments, dataset refinement 630 and retraining may be performed periodically or on demand.

By incorporating user interaction into the dataset generation and training workflow, the system enables targeted refinement of recognition capabilities without requiring manual annotation of large volumes of real-world data. This feedback-driven refinement supports rapid adaptation of the AI recognition model 510 to new behaviors, conditions, or environments.

### Multi-Modal Data Inputs and Extensions

In one or more embodiments, the system may incorporate multi-modal data inputs in addition to two-dimensional (2D) image data to enhance generation of synthetic training data or improve recognition accuracy. Such multi-modal inputs are optional and may be used independently or in combination with image-based inputs.

Multi-modal data inputs may include, by way of example and not limitation, depth data, LiDAR data, radio-frequency (RF) data, audio data, temperature data, environmental sensor data, or other non-visual signals associated with a target object, subject, or scene. The multi-modal data may be captured concurrently with image data or obtained from separate sensing systems.

In some embodiments, multi-modal data may be provided as input to the synthetic modeling engine 120 to refine or validate spatial characteristics of the generated three-dimensional (3D) model. For example, depth or LiDAR data may be used to improve estimation of object geometry, scale, or distance, while RF or environmental sensor data may be used to model conditions not directly observable in visual imagery.

In other embodiments, multi-modal data may be used during generation of the synthetic training dataset to simulate additional attributes or conditions within the synthetic environment. For example, temperature or lighting data may be used to vary environmental parameters, or audio data may be associated with specific behaviors or events within a modeled sequence.

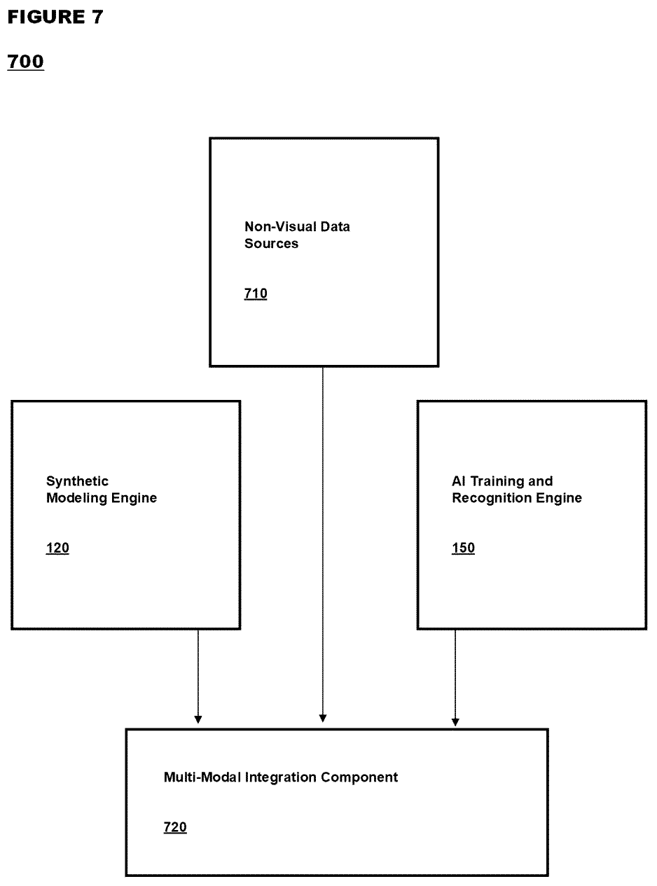

FIG. 7 illustrates incorporation of multi-modal data inputs.

In further embodiments, multi-modal data may be incorporated into the AI training and recognition engine 150 as additional input channels using a multi-modal integration component 720. The recognition model 650 may be retrained to correlate visual patterns with non-visual signals to improve detection or classification of behaviors, conditions, or events. Such multi-modal training may improve robustness in environments where visual data alone is insufficient or degraded.

The system may further support blending of synthetic multi-modal data with real-world multi-modal data 710 during training or validation. Synthetic multi-modal data may be generated to supplement real-world datasets that are sparse, noisy, or difficult to acquire.

The use of multi-modal data inputs does not require any specific sensor type or modality and is intended to provide extensibility of the system across different application domains, sensing technologies, and deployment environments.

### Description of Embodiments/Example Applications and Use Cases

The systems and methods described herein may be applied across a wide range of application domains in which artificial intelligence (AI) systems are trained to identify objects, behaviors, conditions, or events from visual or multi-modal data. The following examples are provided for illustration only and are not intended to limit the scope of the invention.

In one example application, the system may be used for animal or livestock monitoring, including identification of behaviors, movement patterns, or physical conditions. For instance, synthetic training data may be generated to represent indicators of injury, illness, abnormal gait, or other conditions that may be difficult to consistently capture in real-world imagery.

In another example application, the system may be used in surveillance or monitoring environments to identify events or behaviors of interest from limited camera viewpoints. Synthetic data may be generated to model rare or transient events, enabling improved recognition performance using sparse real-world image data 530.

In a further example application, the system may be used in healthcare or medical imaging contexts, where synthetic data may be generated to augment limited real-world datasets. Synthetic training data may be used to represent anatomical variations, conditions, or procedural scenarios while reducing reliance on manually labeled clinical data.

In yet another example application, the system may be used in retail or commercial analytics, including identification of customer behaviors, movement patterns, or event detection within monitored spaces. Synthetic modeling may be used to generate training data representing a range of environmental configurations or behavioral scenarios.

In additional example applications, the system may be used in autonomous or semi-autonomous systems, industrial inspection, sports analytics, or other domains where AI recognition systems benefit from diverse training data derived from limited real-world inputs.

### Example Method Flows

The following example method flows describe representative operations performed by the system for generating synthetic training data and training an artificial intelligence (AI) recognition model. The method flows are provided for purposes of illustration and are not intended to limit the order, combination, or execution of the described operations.

In one example method flow, the system receives one or more two-dimensional (2D) images of a target object, subject, or scene. The images may be captured using a camera from a known or inferable vantage point and may include associated metadata 215 such as camera orientation, distance, or environmental conditions.

The system generates a three-dimensional (3D) model corresponding to the received image data using a synthetic modeling engine 120. The 3D model may represent the target object and, optionally, the surrounding environment, including spatial relationships, scale, pose, and orientation inferred from the 2D image data 210.

Using the generated 3D model, the system produces a plurality of synthetic data instances 320a-320n by varying one or more modeling parameters 310. Such parameters may include camera viewpoint, lighting, object pose, motion, environment, or occlusion. The synthetic data instances 320a-320n may include still images, image sequences, or other representations suitable for training an AI recognition model 510.

The system annotates the synthetic data instances 320a-320n with labels or attributes corresponding to objects, behaviors, conditions, or events represented within the synthetic environment. Annotation may be performed automatically based on known characteristics of the synthetic model or with optional user input 620.

The annotated synthetic data is used to train an AI recognition model 510 to identify corresponding objects, behaviors, or conditions in real-world image data 530. Training may be performed using supervised or other machine learning techniques, and may include retraining or incremental training as additional synthetic data is generated.

In another example method flow, the trained AI recognition model 510 is applied to real-world image or video data to generate recognition outputs 540. The outputs may include identification of behaviors, conditions, or events, and may include spatial localization or confidence information.

In a further example method flow, user input 620 is received identifying a target or undesirable behavior in real-world imagery. Based on the user input 620, the system updates modeling parameters, generates additional synthetic data representing the identified behavior, and retrains the AI recognition model 510 using the updated synthetic training dataset 640.

The operations described above may be performed in various orders, repeated, combined, or omitted depending on application requirements, and may be executed on one or more computing systems.

### Computing Environment and Implementation Considerations

The systems and methods described herein may be implemented using one or more computing devices, each including one or more processors and one or more non-transitory computer-readable storage media. The processors may execute program instructions stored in the computer-readable storage media to perform the operations described in this disclosure.

The computing devices may include, by way of example and not limitation, servers, workstations, desktop computers, laptop computers, mobile devices, edge computing devices, or combinations thereof. The computing devices may operate independently or in a distributed computing environment, including cloud-based or hybrid computing architectures.

Program instructions implementing the synthetic modeling engine 120, training dataset generation, annotation, AI training, recognition, and user interaction components may be executed on a single computing device or distributed across multiple computing systems. In some embodiments, different components of the system may be executed on different devices or at different times.

The computer-readable storage media may include volatile or non-volatile memory, including but not limited to random-access memory (RAM), read-only memory (ROM), flash memory, magnetic storage, optical storage, or other storage technologies now known or later developed. The storage media may store program instructions, synthetic data, real-world image data 530, annotations, trained AI models, or other data used by the system.

The computing devices may communicate with one another via one or more networks, including wired or wireless networks. Network communications may occur using any suitable communication protocol. Input and output devices may include cameras, sensors, displays, user input devices, or other peripheral components.

The AI recognition models 510 trained by the system may be deployed in centralized environments or distributed to remote or edge devices for execution. In some embodiments, trained models may be optimized for deployment on resource-constrained devices or for real-time processing.

The described computing environment is provided for purposes of example and does not impose limitations on the manner in which the disclosed systems and methods may be implemented or deployed.

### Interpretation and Scope

Unless otherwise indicated, all terms used herein are to be given their broadest reasonable interpretation consistent with the specification as understood by a person of ordinary skill in the art.

As used herein, the terms “including,” “includes,” “include,” and “comprising” are open-ended and do not exclude the presence of additional, unrecited elements or steps.

The singular forms “a,” “an,” and “the” include plural referents unless the context clearly indicates otherwise.

References to embodiments, examples, or illustrative implementations are provided for explanatory purposes only and are not intended to limit the scope of the invention. Not all described features are required in every embodiment, and features from different embodiments may be combined in any suitable manner.

Functional descriptions of elements or components are not intended to invoke 35 U.S.C. § 112(f) unless the term “means for” is expressly used.

Unless explicitly stated otherwise, the order of steps in any described method is not limiting, and steps may be performed in any order, simultaneously, or in overlapping sequences.

Any reference to components being “coupled,” “connected,” or “communicating” with one another includes direct and indirect connections, wired or wireless connections, and communication through one or more intermediate components.

Functions described as being performed by hardware may alternatively be implemented using software, firmware, or any combination thereof, and vice versa.

Terms such as “about,” “approximately,” or “substantially” are intended to encompass reasonable variations consistent with the operation of the described embodiments and the understanding of a person of ordinary skill in the art.

The scope of the invention is defined by the claims, and not by the foregoing description. The claims are intended to cover all modifications, equivalents, and alternatives falling within the spirit and scope of the invention.

1. A system for training an artificial intelligence (AI) recognition model, comprising:
one or more processors; and
one or more non-transitory computer-readable storage media storing instructions that, when executed by the one or more processors, cause the system to:
(a) receive one or more two-dimensional (2D) images of a real-world object, subject, or scene captured from a limited number of camera viewpoints;
(b) generate, using a synthetic modeling engine 120, a three-dimensional (3D) synthetic representation corresponding to the received one or more 2D images, the 3D synthetic representation including inferred spatial characteristics of the object, subject, or scene;
(c) produce a synthetic training dataset from the 3D synthetic representation by generating a plurality of synthetic data instances that vary at least one of viewpoint, pose, motion, lighting, environment, or behavior;
(d) automatically annotate the synthetic training dataset with labels corresponding to one or more behaviors, conditions, or attributes represented in the 3D synthetic representation;
(e) train an AI recognition model using the synthetic training dataset as a primary training substrate; and
(f) apply the trained AI recognition model to real-world image data to identify one or more behaviors, conditions, or events corresponding to those represented in the synthetic training dataset.

2. The system of claim 1, wherein the one or more 2D images are captured from a single stationary camera having a known or inferable vantage point relative to the object, subject, or scene.

3. The system of claim 1, wherein generating the 3D synthetic representation comprises inferring depth, scale, pose, and orientation of the object, subject, or scene from the received one or more 2D images.

4. The system of claim 1, wherein automatically annotating the synthetic training dataset comprises labeling behavior states or transitions across a sequence of synthetic data instances generated from the 3D synthetic representation.

5. The system of claim 1, wherein the synthetic training dataset comprises a majority of training data used to train the AI recognition model relative to real-world image data.

6. The system of claim 1, further comprising receiving user input identifying a target or undesirable behavior in real-world image data and, in response, updating the synthetic training dataset and retraining the AI recognition model using the updated synthetic training dataset.

7. A computer-implemented method for training an artificial intelligence (AI) recognition model, comprising:
(a) receiving one or more two-dimensional (2D) images of a real-world object, subject, or scene captured from a limited number of camera viewpoints;
(b) generating, by one or more processors using a synthetic modeling engine 120, a three-dimensional (3D) synthetic representation corresponding to the received one or more 2D images, the 3D synthetic representation including inferred spatial characteristics of the object, subject, or scene;
(c) producing a synthetic training dataset from the 3D synthetic representation by generating a plurality of synthetic data instances that vary at least one of viewpoint, pose, motion, lighting, environment, or behavior;
(d) automatically annotating the synthetic training dataset with labels corresponding to one or more behaviors, conditions, or attributes represented in the 3D synthetic representation;
(e) training an AI recognition model using the synthetic training dataset as a primary training substrate; and
(f) applying the trained AI recognition model to real-world image data to identify one or more behaviors, conditions, or events corresponding to those represented in the synthetic training dataset.

8. The method of claim 7, wherein receiving the one or more 2D images comprises capturing the one or more 2D images from a single stationary camera having a known or inferable vantage point relative to the object, subject, or scene.

9. The method of claim 7, wherein generating the 3D synthetic representation comprises inferring depth, scale, pose, and orientation of the object, subject, or scene from the received one or more 2D images.

10. The method of claim 7, wherein producing the synthetic training dataset comprises generating a sequence of synthetic data instances representing motion or behavioral transitions of the object, subject, or scene over time.

11. The method of claim 7, wherein automatically annotating the synthetic training dataset comprises labeling behavior states or transitions across the sequence of synthetic data instances.

12. The method of claim 7, wherein the synthetic training dataset comprises a majority of training data used to train the AI recognition model relative to real-world image data.

13. The method of claim 7, further comprising receiving user input identifying a target or undesirable behavior in real-world image data and, in response, updating the synthetic training dataset and retraining the AI recognition model using the updated synthetic training dataset.

14. The method of claim 7, further comprising deploying the trained AI recognition model to a remote or edge computing device for application to real-world image data.

15. A computer system for generating training data for an artificial intelligence (AI) recognition system, comprising:
one or more processors; and
one or more non-transitory computer-readable storage media storing instructions that, when executed by the one or more processors, cause the system to:
(a) obtain image data corresponding to a real-world object, subject, or scene, the image data including two-dimensional (2D) image information captured from one or more camera viewpoints;
(b) generate synthetic three-dimensional (3D) modeled data corresponding to the image data, the synthetic 3D modeled data representing spatial and behavioral characteristics of the object, subject, or scene;
(c) automatically generate annotated synthetic training data from the synthetic 3D modeled data, the annotated synthetic training data including labels associated with behaviors, conditions, attributes, or events; and
(d) provide the annotated synthetic training data for use in training one or more AI recognition models configured to identify corresponding behaviors, conditions, attributes, or events in real-world data,
wherein the synthetic training data enables training of the AI recognition system using substantially less manually labeled real-world data than would otherwise be required.

16. The system of claim 15, wherein generating the synthetic three-dimensional (3D) modeled data comprises varying environmental or scene parameters selected from lighting conditions, background geometry, occlusion elements, or spatial reference markers.

17. The system of claim 15, wherein automatically generating annotated synthetic training data comprises associating ground-truth labels derived from the synthetic 3D modeled data without manual pixel-level annotation of real-world images.

18. The system of claim 15, wherein the synthetic 3D modeled data represents a temporal sequence of modeled states corresponding to a progression of a behavior, condition, or event.

19. The system of claim 15, further comprising incorporating non-visual sensor data as an input to the generation of the synthetic 3D modeled data or the annotated synthetic training data.

20. The system of claim 15, wherein providing the annotated synthetic training data comprises outputting the annotated synthetic training data to an external AI training platform or recognition system operating independently of the system.
